(19) United States
(12) Patent Application Publication
(10) Pub. No.: US 2005/0217405 A1
(43) Pub. Date: Oct. 6, 2005

(54) Selector apparatus of an automatic transmission of vehicle

(76) Inventor: Takayuki Suzuki, Hamana-gun (JP)

Correspondence Address: HARNESS, DICKEY & PIERCE, P.L.C., P.O. BOX 828, BLOOMFIELD HILLS, MI, 48303, US

(21) Appl. No.: 11/090,870

(22) Filed: Mar. 25, 2005

(30) Foreign Application Priority Data
Mar. 25, 2004 (JP) 2004-089721

(51) Int. Cl. F16H 27/02

(52) U.S. Cl. 74/473.12

(57) ABSTRACT

A vehicle automatic transmission selector apparatus which can achieve both good operability and size reduction has brackets (1a and 1b) to be secured on a body of a vehicle. A selector lever (2) is pivotally supported on the brackets (1a and 1b). A lever bracket (3) is arranged at a base end of the selector lever (2) and formed with sector gear teeth (3a). A selector-link (4), to actuate a transmission via a wire (W) interposed between the selector-link (4) and the transmission, is formed with sector gear teeth (4a). The teeth (4a) mate with the sector gear teeth (3a) of the lever bracket (3). The selector-link is rotated by the pivotal motion of the selector lever (2). The module of the teeth (3a and 4b) of sector gears of the lever bracket (3) and the selector-link (4) is set within a range between 1.0˜3.0.

### CROSS-REFERENCE TO RELATED APPLICATION

This application claims priority to Japanese Patent Application No. 2004-089721, filed Mar. 25, 2004, which application is herein expressly incorporated by reference.

### FIELD OF THE INVENTION

The present invention relates to a shift selector for vehicle automatic transmissions to carry out the shifting operation of the transmission by transmitting the pivotal motion of the selector lever to a select-link, via a gear arrangement.

### BACKGROUND OF THE INVENTION

In general, a selector apparatus has a selector lever operated by a driver provided on a vehicle with an automatic transmission. The selector lever can be pivotally moved, for example, to a parking position (P), a reverse position (R), a neutral position (N) and a drive position (D). The base end of the selector lever includes a lever bracket, which has an aperture to receive the pivotal shaft of the selector lever, and is connected to the automatic transmission via a push-pull wire.

Various structures of selector apparatus have been required to be adapted to the many vehicle interior layout limitations in order to satisfy desires of the users. Accordingly, in Japanese Laid-open Patent Publication No. 315070/1995, a selector apparatus is proposed with a gear arrangement to correspond to the shifting direction of the selector lever and the moving direction of the push-pull wire.

In the selector apparatus of the prior art, a lever bracket is formed with teeth of a sector gear. Also, a select-link is provided with a sector gear having teeth mating with the lever bracket sector gear. The select-link is pivotally mounted on a bracket similar to the selector lever and is connected to an automatic transmission by an extending push-pull wire. The transmission can be actuated by a driver operating the selector lever, via the sector gear arrangement and the push-pull wire.

However, problems exists in the prior art vehicle automatic transmission selector apparatus due to the strength of teeth of the sector gear arrangement and its operability. The strength of the teeth of the sector gear arrangement is reduced if the pitch of teeth is reduced to improve the operability. Contrary to this, if the pitch of the teeth is increased to increase the strength, a large play is created in the selector apparatus and thus the operability is deteriorated.

It is desirable to design the selector apparatus to reduce its size to adapt the selector apparatus to requirements in the design of the interior of the vehicle. In such a case, it is possible to have high strength teeth by increasing the teeth face width while keeping the pitch of teeth moderately small to provide good operability. However, increase of the face width will increase the overall size of the selector apparatus.

### SUMMARY OF THE INVENTION

It is, therefore, an object of the present invention to provide a selector apparatus of a vehicle automatic transmission which can achieve both good operability and size reduction without reducing or damaging teeth strength.

According to the present invention, a vehicle automatic transmission selector apparatus comprises at least one bracket to be secured on a body of a vehicle. A selector lever is pivotally supported on the brackets. A lever bracket is arranged at a base end of the selector lever and formed with sector gear teeth. A selector-link, to actuate a transmission via a wire interposed between the selector-link and the transmission, is formed with sector gear teeth mating with the sector gear teeth of the lever bracket. The selector-link is rotated by the pivotal motion of the selector lever. The module of the teeth of sector gears of the lever bracket and the selector-link is set within a range 1.0˜3.0.

Preferably, the axis of the selector lever is arranged substantially normal to its pivotal axis. Also, preferably, the axis of the selector lever is arranged within the face width of the teeth of the sector gears of the lever bracket and the selector-link.

According to the invention, since the module of the teeth of sector gears of the lever bracket and the selector-link is set within a range of about 1.0 to about 3.0, it is possible to achieve both good operability and size reduction without reducing or damaging the strength of the teeth.

Further, according to the invention, since the pivotal motion of the selector lever can be transmitted to the select-link without any deviation, it is possible to prevent partial abrasion of the gear teeth and to suppress the generation of play in the mating gear teeth. Accordingly, it is possible to further improve the operability of the selector apparatus.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a perspective view of a vehicle automatic transmission selector apparatus of a preferred embodiment of the present invention;

FIG. 2 is a side elevation view of the selector apparatus of FIG. 1, with one of the brackets removed;

FIG. 3 is a exploded perspective view of the selector apparatus of FIG. 1.

FIG. 4 is a graph to provide an optimum module of sector gears used in the selector apparatus of the present invention.

### DETAILED DESCRIPTION OF THE PREFERRED EMBODIMENTS

A preferred embodiment of the invention will be described with reference to accompanied drawings.

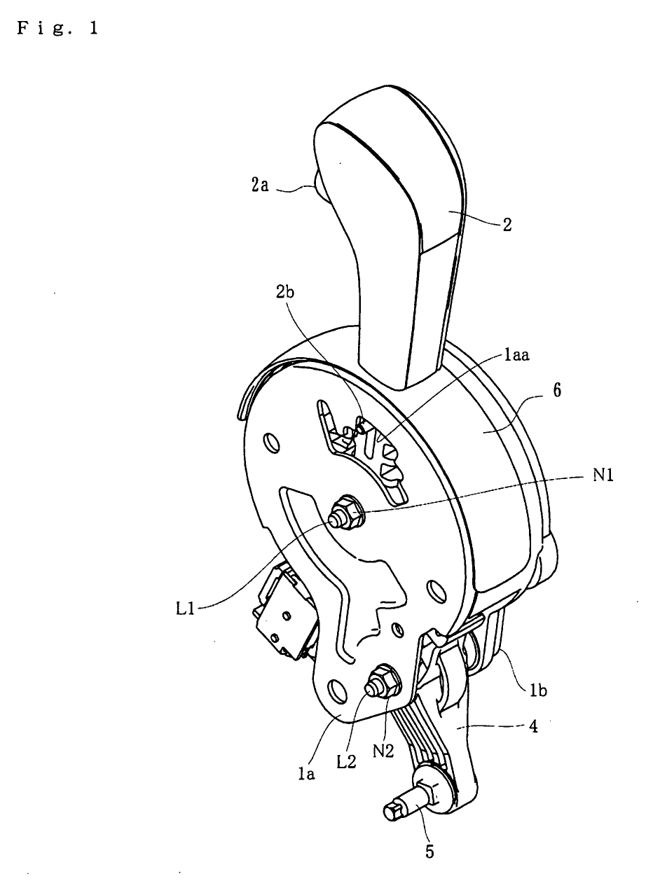

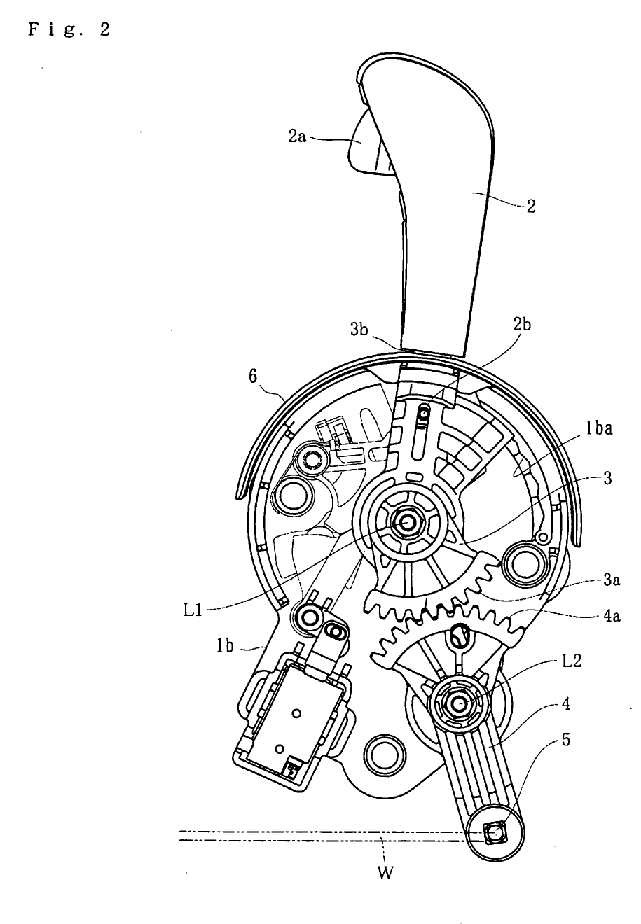

A vehicle automatic transmission selector apparatus of the present invention is a type which can select any driving position of an automatic transmission by transmitting the pivotal motion of a selector lever to a select-link, via sector gears. As shown in FIG. 1, the selector apparatus includes brackets 1a and 1b to be secured on a body of a vehicle. A selector lever 2 is pivotally supported within the brackets 1a and 1b. A lever bracket 3 (see FIG. 2) is mounted on the base end of the selector lever 2. A select-link 4 is coupled with the selector lever 2.

The bracket 1a is formed from a metal sheet member and includes an erroneous operation preventing window 1aa. The window 1aa has a configuration according to positions of the selector lever 2 as well as apertures to enable passing through of shafts L1 and L2, respectively, of the selector lever 2 and select link 4. The bracket 1a is combined with bracket 1b to form a box structure of the selector apparatus to be mounted on a body of the vehicle.

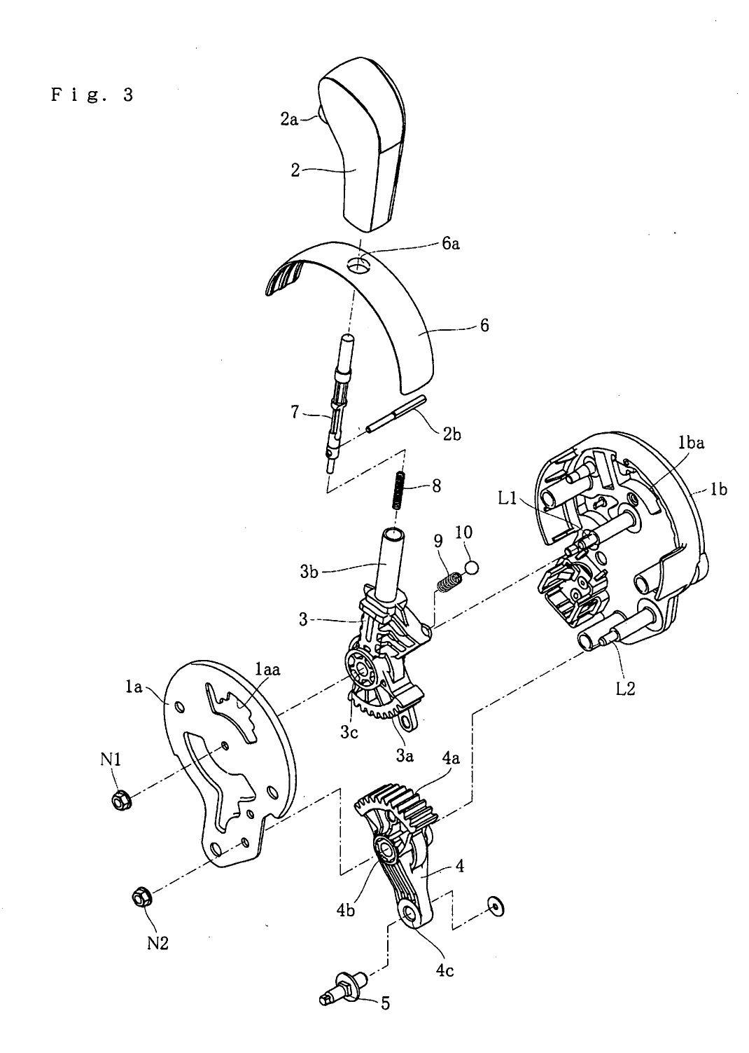

The bracket 1b has shafts L1 and L2 to pivotally support the lever bracket 3 and the select-link 4, respectively. The bracket 1b is formed with a wave-shaped portion 1ba on its upper side wall. A ball 10 (see FIG. 3), supported on the lever bracket 3 via a detent spring 9, abuts on the surface of the wave-shaped portion 1ba to provide a “shift-click feeling” of the selector lever 2 to a driver of the vehicle. After the lever bracket 3 and the select-link 4 etc. are assembled to the bracket 1b, the bracket 1a is also assembled to the bracket 1b. Nuts N1 and N2 are finally screwed onto threads formed on ends of the shafts L1 and L2.

The selector lever 2, pivotally operated by a driver of the vehicle, has a push knob 2a (see FIG. 2) at its top end. The selector lever 2 is connected, at its bottom end, to the lever bracket 3 via a lever pipe 3b (see FIG. 3). A rod lock pin 7 is arranged within the lever pipe 3b, via a spring 8. A lock pin 2b, engaging the erroneous operation preventing window 1aa, is passed through the rod lock pin 7 and the lever bracket 3.

When the selector lever 2 is in the parking position (P), the lock pin 2b engages the erroneous operation preventing window 1aa. The pin 2b prevents the selector lever 2 from being shifted toward the reverse position (R). In such a case, if the push knob 2a is pushed down, the rod lock pin 7 is moved downward against a urging force of the spring 8. Thus, the lock pin 2b is released and the selector lever 2 is allowed to pivot from the parking position (P) to the reverse position (R).

Similarly, pivotal motion of the selector lever 2 is prevented unless the push knob 2a is pushed down in cases of shifting the selector lever 2 from the reverse position (R) to the parking position (P), from the neutral position (N) to the reverse position (R), and from the drive position (D) to the second speed position (2).

The lever bracket 3 is formed with a bore 3c. The shaft L1 is passed through the bore 3c. Also, the lever bracket 3 is formed with teeth 3a of a sector gear at a position lower than the bore 3c.

Similarly to the lever bracket 3, the select-link 4 is formed with a bore 4b. The shaft L2 is passed through the bore 4b. Also, the select-link 4 is formed, at its top end, with teeth 4a of a sector gear. The teeth 4a mate with the teeth 3a of the sector gear of the lever bracket 3. The bottom end of the select-link 4 is formed with a bore 4c. An end bolt 5, to connect a push-pull wire W, is passed through the bore 4c.

The pivotal motion of the selector lever 2 is transmitted to the select-link 4 via the sector gears. Thus, the automatic transmission is operated via the push-pull wire W. In this case, the direction of the pivotal motion of the selector lever 2 is the same as the moving direction of the wire W. A reference numeral 6 in FIG. 3 denotes a selector lever cover. The cover 6 moves together with the selector lever 2, which passed through an aperture 6a formed substantially at the center of the cover 6a.

In the selector apparatus of the present invention, the module (pitch diameter/number of teeth) of teeth 3a and 4a of the sector gears, respectively, of the lever bracket 3 and select-link 4 is set within a range 1.0˜3.0.

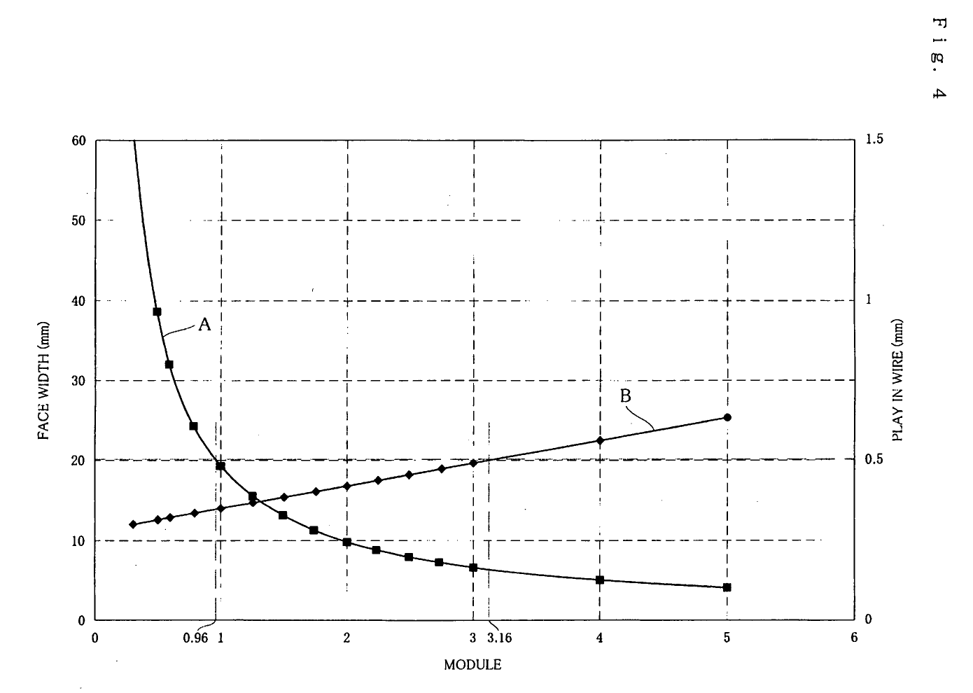

FIG. 4 is a graph showing a curve A of a relation between the face width (mm) of the teeth 3a and 4a illustrating a predetermined condition (ordinate) and the module (abscissa). A curve B is a relation between the play (mm) in the push-pull wire W (amount of displacement of the wire W when the selector lever 2 is in a stationary condition) (ordinate) and the module (abscissa). The predetermined condition is the face width of the teeth (material: PA6-GF30) which can withstand a load of 100 kgf applied on the wire W which is connected to the end bolt 5 of the apparatus of the automatic transmission under conditions: safety factor 1.5, room temperature and 65% RH.

It has been found that the face width of the teeth of the sector gear is preferably about 20 mm to satisfy the size reduction requirement of the selector apparatus. The play is preferably about 0.5 mm to achieve good operability of the selector apparatus. It can be read from the curve A in the graph of FIG. 4 that the value of the module corresponding to the value of face width less than 20 mm is 0.96 or more and that the value of the module corresponding to the value of play less than 0.5 mm is 3.16 or less.

Thus, when the module of the teeth 3a and 4a is set within 0.96˜3.16, with more certainty, between 1.0˜3.0, it is possible to reduce the face width of the teeth to less than 20 mm. This satisfies the teeth strength as well as reduces the play of wire W. Further, face width of less than 20 mm provides good operability of the selector apparatus. In addition, setting of the face width of the teeth at an ideal value less than 20 mm makes it possible to reduce the size of the box structure of the brackets and thus the size of the selector apparatus.

Furthermore, in the preferred embodiment of the present invention, the axis of the selector lever (the axis of the lever pipe 3b) is arranged substantially normal to its pivotal axis L1. The axis of the selector lever is positioned within the face width of the teeth 3a and 4a of the lever bracket 3 and select-link 4. Such an arrangement makes it possible to eliminate partial loading in the face width direction of teeth 3a and 4a and to prevent partial abrasion of the teeth 3a and 4a. Accordingly, this further contributes to the reduction of the generation of the play and improves operability of the selector apparatus.

The present invention has been described with reference to the preferred embodiment. Obviously, modifications and alternations will occur to those of ordinary skill in the art upon reading and understanding the preceding detailed description. For example, the present invention can be applied to those having brackets 1a and 1b or selector lever 2 of different configuration. Of course, the present invention can also be applied to a selector apparatus with any type of parking lock mechanism.

The present invention can be applied to any selector apparatus having a different outline configuration or additional function so long as it has a module within 1.0˜3.0 of the teeth of the sector gears.

The description of the invention is merely exemplary in nature and, thus, variations that do not depart from the gist of the invention are intended to be within the scope of the invention. Such variations are not to be regarded as a departure from the spirit and scope of the invention.

1. A vehicle automatic transmission selector apparatus comprising:
at least one bracket to be secured on a body of a vehicle;
a selector lever pivotally supported on the at least one bracket;
a lever bracket arranged at a base end of the selector lever and formed with sector gear teeth;
a selector-link, for actuating a transmission via a wire interposed between the selector-link and the transmission, formed with sector gear teeth mating with the sector gear teeth of the lever bracket and rotated by pivotal motion of the selector lever; and
a module of the teeth of sector gears of the lever bracket and the selector-link is set within a range between 1.0˜3.0.

2. The selector apparatus of claim 1, wherein the axis of the selector lever is arranged substantially normal to its pivotal axis.

3. The selector apparatus of claim 2, wherein the axis of the selector lever is arranged within the face width of the teeth of sector gears of the lever bracket and the selector-link.
